(19) United States
(12) Patent Application Publication
(10) Pub. No.: US 2013/0191778 A1
(43) Pub. Date: Jul. 25, 2013

(54) Semantic Zooming in Regions of a User Interface

(71) Applicants: Johan Christiaan Peters, Sankt Leon-Rot (DE); Udo Arend, Heidelberg (DE); Vera Legisa, Karlsruhe (DE)

(72) Inventors: Johan Christiaan Peters, Sankt Leon-Rot (DE); Udo Arend, Heidelberg (DE); Vera Legisa, Karlsruhe (DE)

(73) Assignee: SAP AG, Walldorf (DE)

(21) Appl. No.: 13/357,810

(22) Filed: Jan. 25, 2012

(51) Int. Cl. G06F 3/048

(52) U.S. Cl. 715/786; 715/792

(57) ABSTRACT

Example systems and methods of semantic zooming in a user interface are presented. In one implementation, a display including a plurality of non-overlapping regions is presented. A user selection of a first region presenting a first amount of information is received. In response to the user selection, the selected first region is enlarged, and a second amount of information greater than the first amount of information is presented in the first region. At least one remaining region is reduced in size so that the regions continue to be non-overlapping.

### FIELD

The present disclosure relates generally to user interfaces, and more specifically, to semantic zooming in regions or areas of a user interface.

### BACKGROUND

A popular method by which data may be presented in a visual interface is a treemap, by which hierarchical, or tree-structured, data are presented using nested or overlapping rectangles. In most cases, each branch of the tree-structured data is represented with a separate rectangle, and sub-branches are represented by smaller rectangles located within the larger “parent” branch rectangle. Further, one or more sub-branches may include even smaller rectangles. This process may continue for an indefinite number of data levels. Also, the area of each rectangle is often proportional to some dimension or aspect of the data being represented by the treemap. In some implementations, the color or shade of each rectangle may represent another data dimension. In situations in which multiple levels of data are involved, the size of the rectangles for the lowest data levels may be exceedingly small.

To enhance readability of data on a display, some systems provide a zooming or zoomable user interface (ZUI), a type of graphical user interface (GUI) in which a user may alter the scale of a display to view details of the display that may otherwise be too small to read or discern. Generally, after “zooming in” to view some portion of the display in detail, the user may then “zoom out” to restore the original scale of the display to view the overall layout of the display, possibly to zoom in to another area of the display. Such zooming may be termed “graphical zoom”, as the relative proportions of the various visual elements that are provided in the display, as well as the visual content provided, are not altered during zooming operations.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system having a client-server architecture for an enterprise application platform capable of employing the systems and methods described herein;

FIG. 2 is a block diagram of example applications and modules employable in the enterprise application platform of FIG. 1;

FIG. 3 is a block diagram of example modules utilized in the enterprise application platform of FIG. 1 for systems and methods of semantic zooming in a user interface;

FIG. 4A is a flow diagram of an example method of semantic zooming for a zoom-in operation;

FIG. 4B is a flow diagram of an example method of semantic zooming for a zoom-out operation;

FIG. 5 is a flow diagram of an example method of query/response communications related to a semantic zooming operation;

FIGS. 6A through 6G are example user interface displays exemplifying semantic zooming; and

FIG. 7 depicts a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Various example methods and systems described below facilitate semantic zooming in a user interface. For example, the user interface may display a number of non-overlapping regions, with each region providing some amount of information associated with that region. In response to a user selecting one of the regions, the selected region may be enlarged, thus allowing the display of more information, possibly including more detailed information, relating to the selected region. In addition, one or more of the other displayed regions are reduced in size so that the regions remain in a non-overlapping state. As a result, details regarding information associated with one of the regions may be displayed while allowing the remaining regions and their associated information to remain in view. Other aspects of the embodiments discussed herein may be ascertained from the following detailed description.

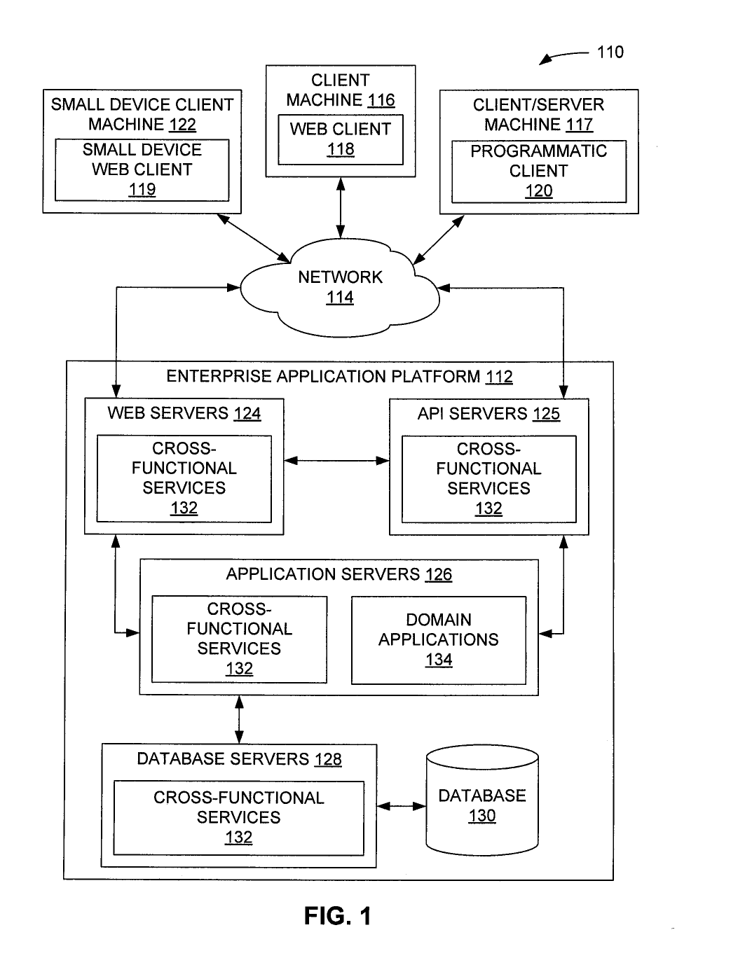

FIG. 1 is a network diagram depicting an example system 110, according to one exemplary embodiment, having a client-server architecture configured to perform the various methods described herein. A platform (e.g., machines and software), in the exemplary form of an enterprise application platform 112, provides server-side functionality via a network 114 (e.g., the Internet) to one or more clients. FIG. 1 illustrates, for example, a client machine 116 with a web client 118 (e.g., a browser, such as the Internet Explorer® browser developed by Microsoft Corporation of Redmond, Washington State), a small device client machine 122 with a small device web client 119 (e.g., a browser without a script engine) and a client/server machine 117 with a programmatic client 120.

Turning specifically to the enterprise application platform 112, web servers 124, and Application Program Interface (API) servers 125 are coupled to, and provide web and programmatic interfaces to, application servers 126. The application servers 126 are, in turn, shown to be coupled to one or more database servers 128 that may facilitate access to one or more databases 130. The web servers 124, Application Program Interface (API) servers 125, application servers 126, and database servers 128 may host cross-functional services 132. The application servers 126 may further host domain applications 134.

The cross-functional services 132 may provide user services and processes that utilize the enterprise application platform 112. For example, the cross-functional services 132 may provide portal services (e.g., web services), database services, and connectivity to the domain applications 134 for users that operate the client machine 116, the client/server machine 117, and the small device client machine 122. In addition, the cross-functional services 132 may provide an environment for delivering enhancements to existing applications and for integrating third party and legacy applications with existing cross-functional services 132 and domain applications 134. Further, while the system 110 shown in FIG. 1 employs a client-server architecture, the present disclosure is of course not limited to such an architecture, and could equally well find application in a distributed or peer-to-peer architecture system.

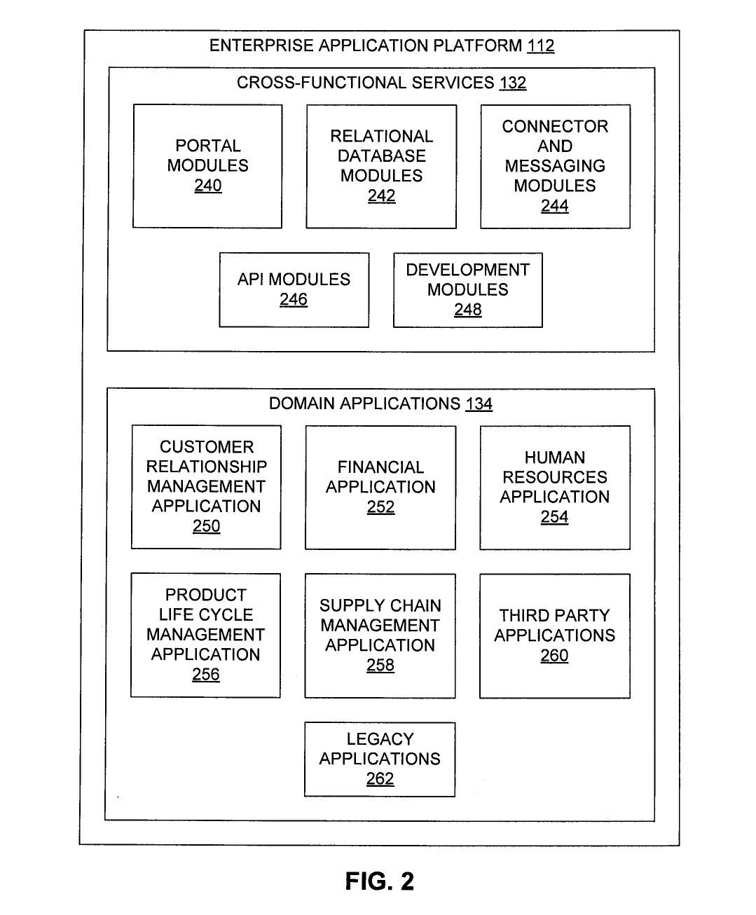

FIG. 2 is a block diagram illustrating example enterprise applications and services, such as those described herein, as embodied in the enterprise application platform 112, according to an exemplary embodiment. The enterprise application platform 112 includes the cross-functional services 132 and the domain applications 134. The cross-functional services 132 include portal modules 240, relational database modules 242, connector and messaging modules 244, Application Program Interface (API) modules 246, and development modules 248.

The portal modules 240 may enable a single point of access to other cross-functional services 132 and domain applications 134 for the client machine 116, the small device client machine 122, and the client/server machine 117 of FIG. 1. The portal modules 240 may be utilized to process, author, and maintain web pages that present content (e.g., user interface elements and navigational controls) to the user. In addition, the portal modules 240 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 240 may include, in one implementation, a generation module, a communication module, a receiving module, and a regenerating module. In addition, the portal modules 240 may comply with web services standards and/or utilize a variety of Internet technologies, including, but not limited to, Java, J2EE, SAP's Advanced Business Application Programming Language (ABAP) and Web Dynpro, XML, JCA, JAAS, X.509, LDAP, WSDL, WSRR, SOAP, UDDI, and Microsoft.NET.

The relational database modules 242 may provide support services for access to the database 130 (FIG. 1) that includes a user interface library. The relational database modules 242 may provide support for object relational mapping, database independence, and distributed computing. The relational database modules 242 may be utilized to add, delete, update, and manage database elements. In addition, the relational database modules 242 may comply with database standards and/or utilize a variety of database technologies including, but not limited to, SQL, SQLDBC, Oracle, MySQL, Unicode, and JDBC.

The connector and messaging modules 244 may enable communication across different types of messaging systems that are utilized by the cross-functional services 132 and the domain applications 134 by providing a common messaging application processing interface. The connector and messaging modules 244 may enable asynchronous communication on the enterprise application platform 112.

The Application Program Interface (API) modules 246 may enable the development of service-based applications by exposing an interface to existing and new applications as services. Repositories may be included in the platform as a central place to find available services when building applications.

The development modules 248 may provide a development environment for the addition, integration, updating, and extension of software components on the enterprise application platform 112 without impacting existing cross-functional services 132 and domain applications 134.

Turning to the domain applications 134, a customer relationship management application 250 may enable access to and facilitate collecting and storing of relevant personalized information from multiple data sources and business processes. Enterprise personnel that are tasked with developing a buyer into a long-term customer may utilize the customer relationship management application 250 to provide assistance to the buyer throughout a customer engagement cycle.

Enterprise personnel may utilize a financial application 252 and business processes to track and control financial transactions within the enterprise application platform 112. The financial application 252 may facilitate the execution of operational, analytical, and collaborative tasks that are associated with financial management. Specifically, the financial application 252 may enable the performance of tasks related to financial accountability, planning, forecasting, and managing the cost of finance.

A human resources application 254 may be utilized by enterprise personal and business processes to manage, deploy, and track enterprise personnel. Specifically, the human resources application 254 may enable the analysis of human resource issues and facilitate human resource decisions based on real-time information.

A product life cycle management application 256 may enable the management of a product throughout the life cycle of the product. For example, the product life cycle management application 256 may enable collaborative engineering, custom product development, project management, asset management, and quality management among business partners.

A supply chain management application 258 may enable monitoring of performances that are observed in supply chains. The supply chain management application 258 may facilitate adherence to production plans and on-time delivery of products and services.

Third-party applications 260, as well as legacy applications 262, may be integrated with the domain applications 134 and utilize the cross-functional services 132 on the enterprise application platform 112.

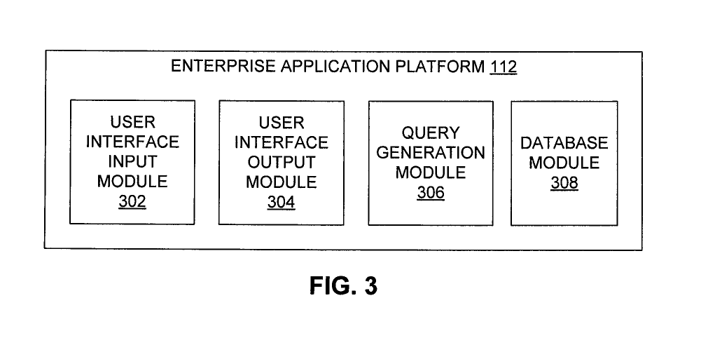

FIG. 3 is a block diagram of example modules employable in the enterprise application platform 112 of FIG. 1 for systems and methods of semantic zooming in a user interface, as mentioned above. In the example of FIG. 3, the enterprise application platform 112 includes a user interface input module 302, a user interface output module 304, a query generation module 306, and a database module 308. In some implementations, one or more of these modules may be incorporated in other modules of the enterprise application platform 112. For example, the user interface input module 302 and the user interface output module 304 may exist as two of the portal modules 240 (FIG. 2), while the database module 310 may be one of the relational database modules 242 (also FIG. 2) or another type of database module or storage facility not explicitly shown in FIG. 2. Further, any of the modules 302 through 308 may be combined into fewer modules, or may be partitioned into a greater number of modules. In yet other examples, the systems and methods described herein may be employed in modules located partially or completely outside the context of the enterprise application platform 112, such as in a client machine 116, 117, 122, or in a computing or communication device not connected with the system 110 of FIG. 1.

The user interface input module 302 may accept input from a user by way of any user input device, such as a keyboard, mouse, or the like. Some embodiments described hereinafter make particular use of a selection button of a mouse (such as the left-side button when operated by a right-handed user) or a scroll wheel of a mouse, but other hardware components of a user input device may be employed in other examples. As discussed below, the input from the user may be utilized to select a region of a display for zooming in or zooming out, to provide user preference information regarding how the regions and associated information are to be displayed, and to facilitate other functionality described below under user control.

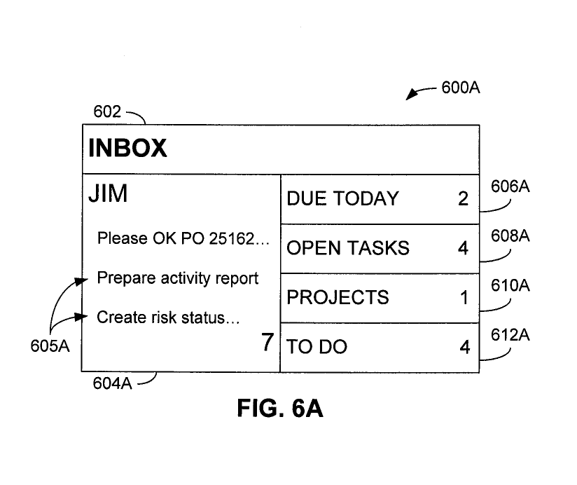

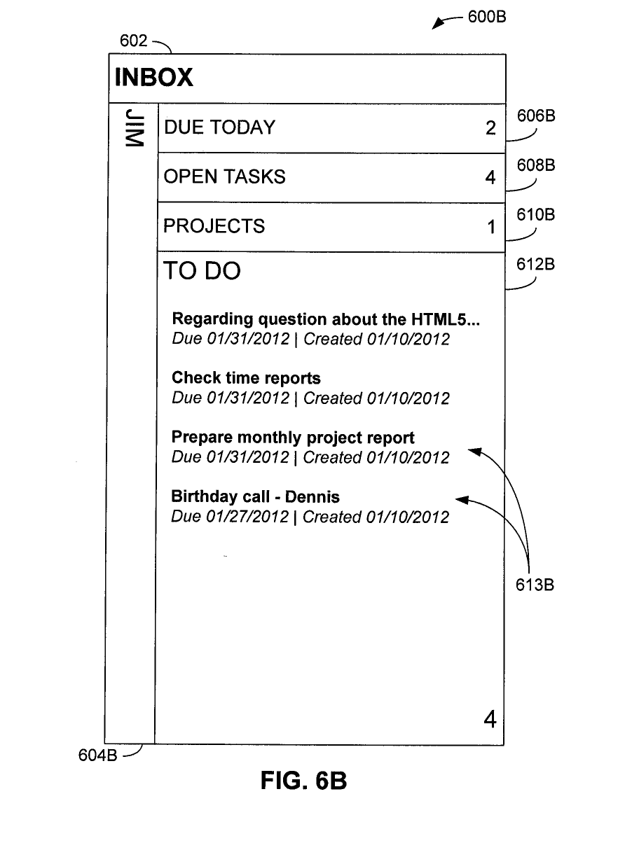

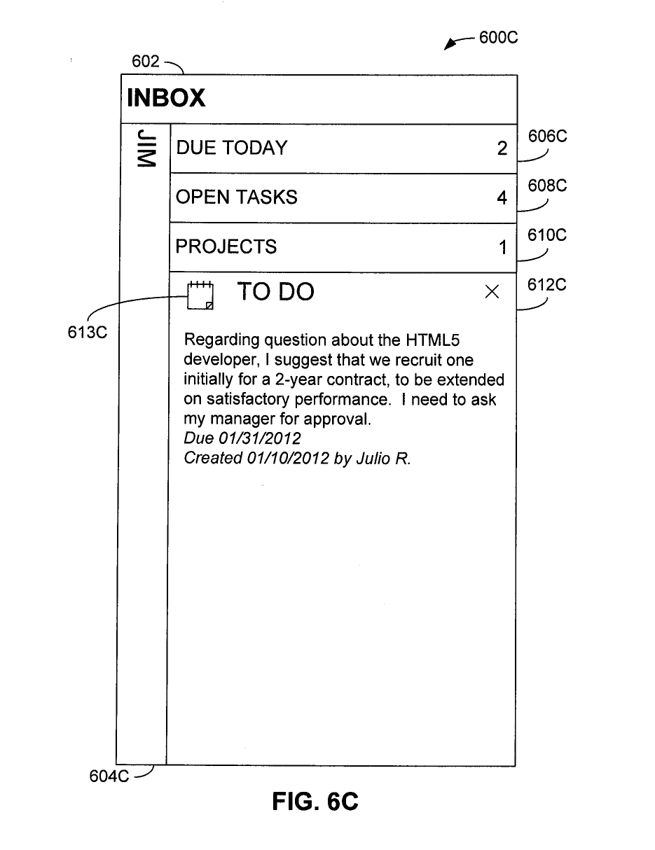

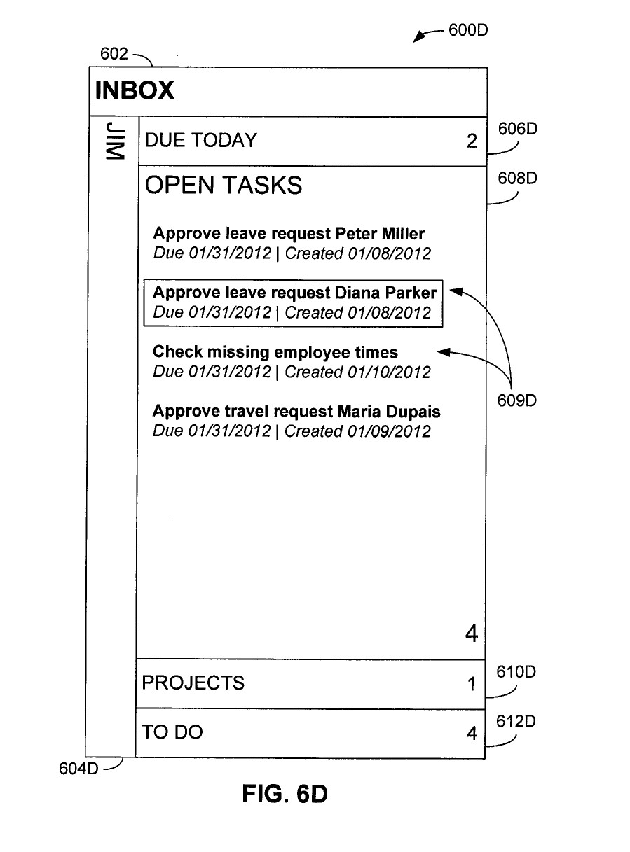

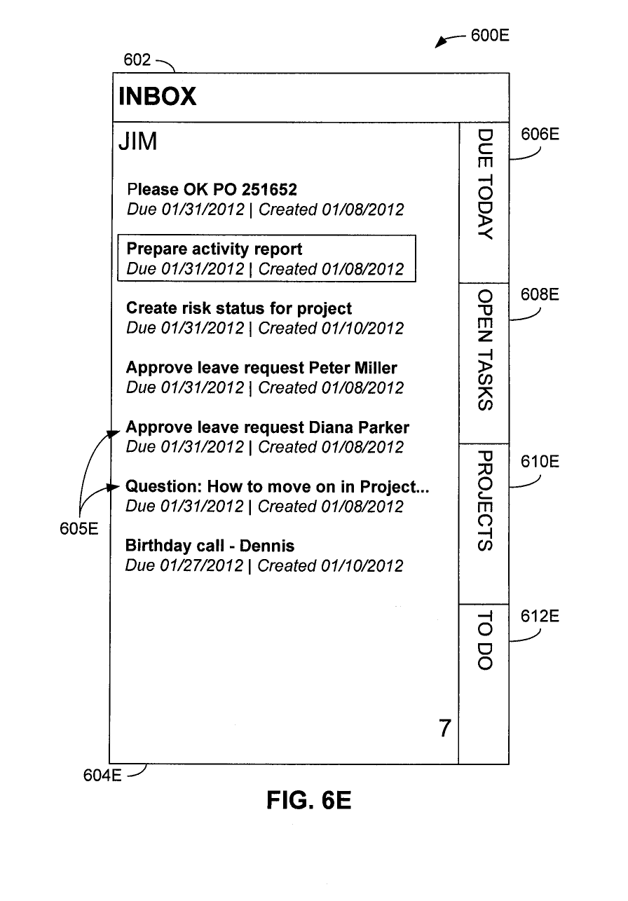

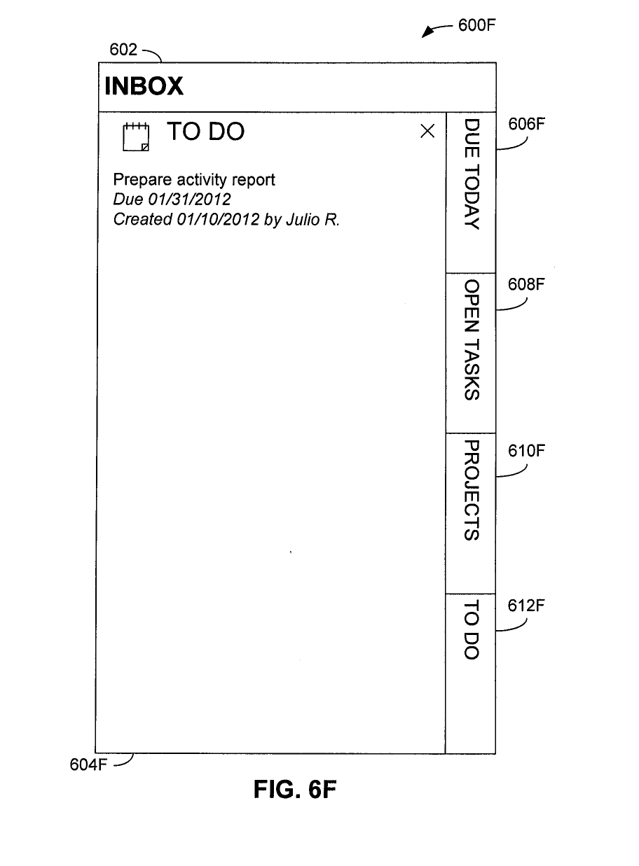

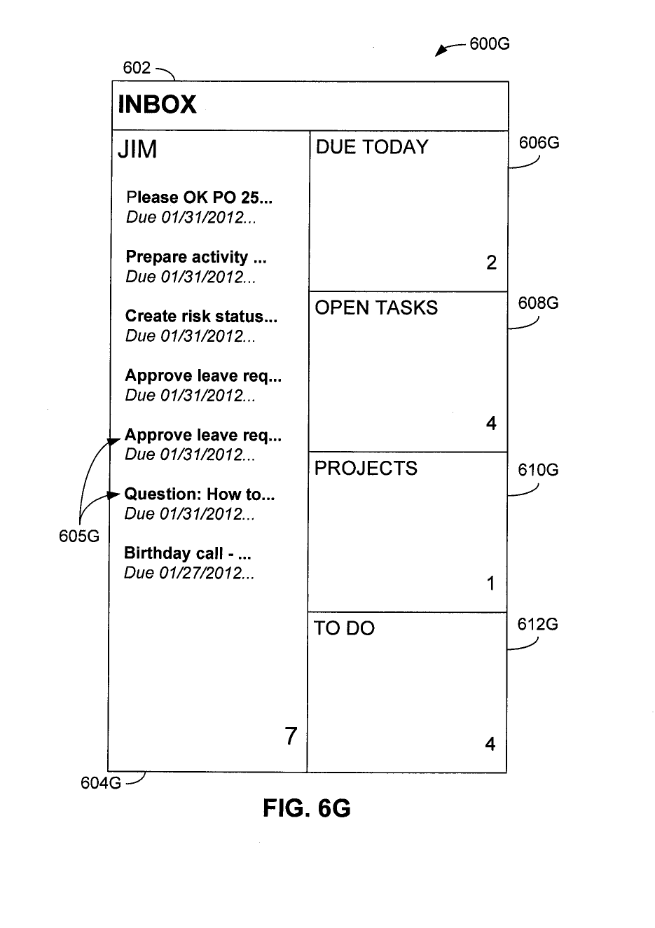

The user interface output module 304 may provide the user with a visual display of multiple regions, such as, for example, rectangles or other convex shapes, along with information associated with, and displayed within, each of the regions. Examples of such displays are provided in FIGS. 6A through 6G, which are described in greater detail below. The user interface output module 304 may present these displays to the user by way of any visual display device, such as a flat panel display for a desktop computer, laptop computer, computer tablet, cellular phone, personal digital assistant (PDA), or other electronic device. The user interface output module 304 may also provide any type of visual interface to allow the user to specify user preferences for the display, to access an item of information indicated in the display, and so on.

The query generation module 306 may generate database queries regarding one or more regions of the display, such as regions specifically selected by the user, and forward the queries to the database module 308. As described below, the queries may include, in some examples, an indication of a region selected by the user, an indication of whether a zoom-in or zoom-out operation is to be performed, and/or the current information or state associated with the selected region. In some implementations, the queries may also specify information related to other regions not currently selected by the user. The query generation module 306 may also receive from the database module 308 a response associated with each forwarded query. The response may include, but is not limited to, the information to be presented in a region, the size of the region to be displayed, and the location of the region to be displayed.

The database module 308 may facilitate the storage and retrieval of information regarding the various regions being presented on a display to the user. Such information may include, for example, the current size and location of each region, as well as the information being presented in each region. In some examples, the information stored via the database module 308 may also include size, location, and/or presentation data for each of the regions presuming one or more zoom-in or zoom-out operations are to be applied thereto. One example of the database module 308 is a relational database, but any other type of storage facility capable of performing the various storage and retrieval functions commensurate with the various examples discussed below may also serve as the database module 308. In some cases, the database data may be stored in the memory of a server or other system, as opposed to an externally-located database, thus facilitating faster read and write access to the information associated with the multiple regions being displayed.

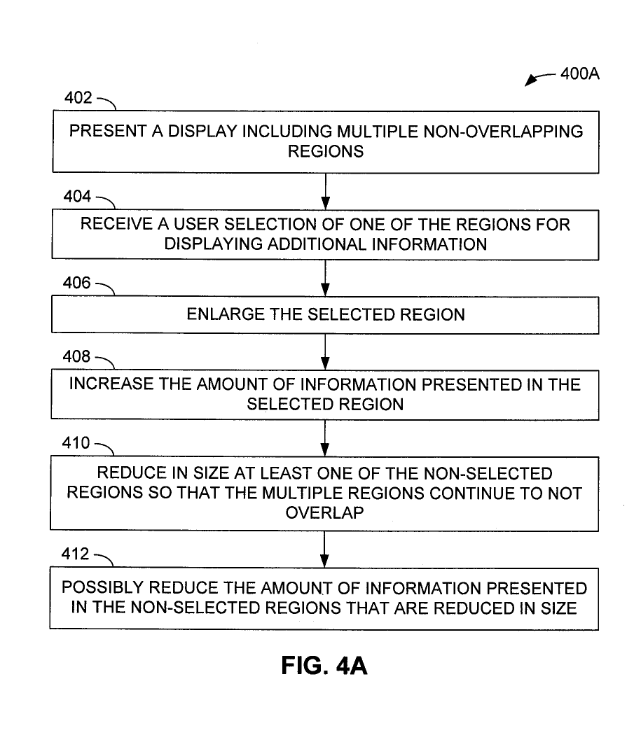

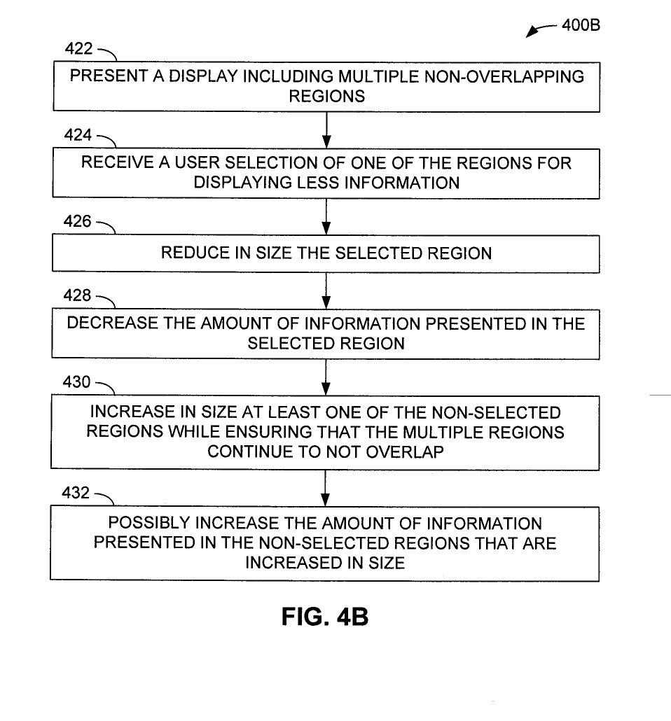

FIG. 4A illustrates an example method 400A of semantic zooming for a zoom-in operation. Generally, a semantic zoom-in operation may result in the enlargement of a particular region of the display, accompanied with the presentation of greater or more detailed information not previously presented in the region. Thus, a semantic zoom-in operation is distinguished from a purely graphical zoom-in operation, in which information previously displayed is enlarged or magnified graphically to facilitate reading of the information. Conversely, FIG. 4B depicts an example method 400B of semantic zooming for a zoom-out operation, in which a region may be shrunk or reduced in size, accompanied with a reduction in information, or in the detail of the information, presented in the region. In some examples, any of the operations depicted in FIGS. 4A and 4B may be performed within the enterprise application platform 112 of FIG. 1 (such as by the modules 302 through 308 of FIG. 3), one or more of the client machines 116, 117, or 122 of FIG. 1, or another computing or communication device.

In the method 400A of FIG. 4A, a display including multiple non-overlapping regions is presented to a user (operation 402). In one example, each of the regions is rectangular or otherwise convex in shape, although other embodiments are not constrained in such a manner. In at least some implementations, a first region is not overlapped by a second region if the first region appears to the user as a convex shape. Each of the regions may also provide some information associated therewith, such as, for example, a title, a topic, a listing of items, or information related to a particular item represented by or in the region.

Continuing with the method 400A, a user selection of one of the regions for the display of additional or more detailed information is received (operation 404). In one example, the user may indicate the selection by way of activating a left-side selection button of a mouse. In another instance, the user may select the region via activation of a mouse scroll wheel. The user may employ other means to indicate the selection of a region in other embodiments.

In response to the user selection (operation 404), the selected region may be enlarged or increased in area or size (operation 406) to allow the inclusion of more information associated with the selected region. In some examples, the actual size and resulting location of the selected region may be determined by information provided by the database module 308, by preferences provided by the user, or by other sources.

In conjunction with the increased area of the selected region, the amount of information presented in the selected region may also be increased (operation 408). Such information, in one example, may be more detailed information regarding a topic or subject area associated with the selected region. For example, if the information presented in the region prior to its selection is a topic area, the information after selection may include a listing of items related to the topic. Similarly, if the information prior to selection is a listing of items, the information subsequent to the selection may include details regarding at least one of the items. Other examples of added or more detailed information may be involved in other embodiments.

If the total display area consumed by the multiple regions is to remain constant, at least one of the non-selected regions may be reduced in area or size (operation 410), and the information presented in the reduced-area regions may also be reduced (operation 412). As a result, details regarding a particular region may be presented while still allowing direct user access to other regions originally displayed.

In some implementations, each potential size or area of each region, and the associated information to be presented for each particular size of region, may be associated with a predetermined level of detail available. In one specific example, each displayed region may be capable of provide a topic (level 1), a listing of items associated with the topic (level 2), and details associated with one or more of the items (level 3). Further, the user may transition from one level to the next, in increasing or decreasing levels of detail. Specifications regarding the number of the levels, the amount of information associated with that level, the area of the region to be associated with a particular level, and other implementation details, may be specified by software (such as the database module 308 of FIG. 3), by user preferences, or by other means.

While the operations of the method 400 of FIG. 4A and other figures provided herein are shown in a specific order, other orders of operation, possibly including concurrent execution of at least portions of one or more operations, may be undertaken in some implementations. For example, the increase in area of the selected region (operation 406), the increase in the amount of information presented in the selected region (operation 408), the decrease in the area of one or more non-selected regions (operation 410), and the associated reduction of information in the reduced-area regions (operation 412) may occur in any order, and may be executed with sufficient speed to appear to the user to occur simultaneously.

Proceeding to FIG. 4B, an example method 400B for a semantic zoom-out operation begins with a display including multiple non-overlapping regions being presented to a user (operation 422). The multiple regions may have aspects similar to those discussed above in conjunction with method 400A (FIG. 4A). A user selection of one of the regions to reduce the amount of information provided in the region is received (operation 424). In response to the selection, the selected region may be reduced in area or size (operation 426), and the amount of information presented in the selected region may be reduced (operation 428). Such a reduction in information may represent a reduction in detail of the information in one implementation. In connection with the area reduction of the selected region, at least one of the non-selected regions may be increased in size (operation 430), and information presented in the enlarged regions may be increased, or be more detailed (operation 432).

Similar to the method 400A of FIG. 4A, the amount of change in the area of a region, and the associated change in the amount of information presented therein, may be determined according to specified levels, as described above. Further, the levels may be predetermined, such as via the database module 308 (FIG. 3) or by user preferences.

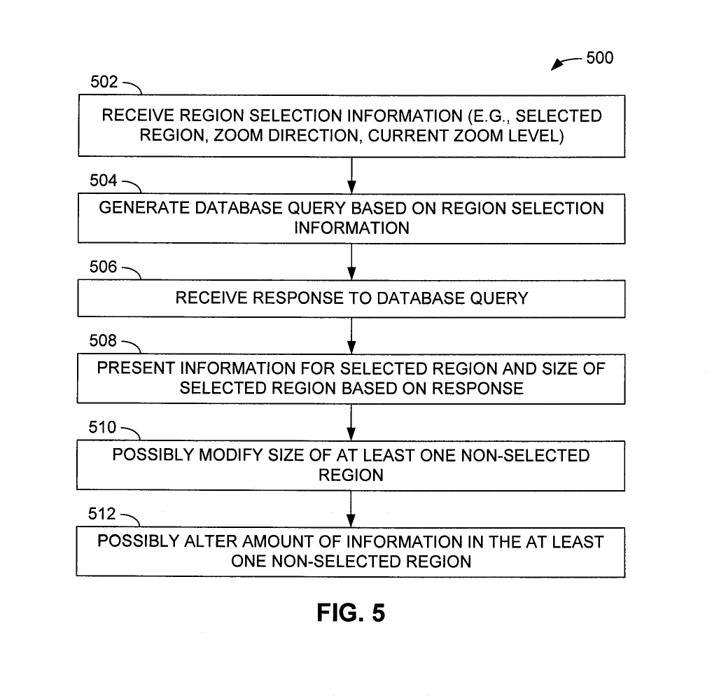

FIG. 5 is a flow diagram of an example method 500 of query/response communications related to a semantic zooming operation. In some implementations, any of the operations of the method 500 may be performed within the enterprise application platform 112 of FIG. 1 (such as by the modules 302 through 308 of FIG. 3), one or more of the client machines 116, 117, or 122 of FIG. 1, or another computing or communication device. In the method 500, region selection information is received (operation 502). In an example, the region selection information may include an identification of the selection region, an indication of the direction of the zoom operation (for example, zoom-in or zoom-out), and an indication of the current zoom level of the selected region. Based on this information, the query generation module 306 (FIG. 3) may generate a database query based on the region selection information (operation 504) and forward the query to the database module 308.

In reply, the query generation module 306 may receive a response to the query (operation 506) from the database module 308. The response, in one example, may include response data specifying the area (and possibly the location) of the region of interest to be presented to the user, along with the information to be presented within the region. In one example, the response data may be in the form of one or more data objects. The user interface output module 304 (FIG. 3) may then employ the response data to size the selected region appropriately and present the specified information in the region. In addition, the response data may also indicate a change in area of one or more other regions (operation 510), as well as a related alteration in the amount of information presented in those regions (operation 512).

In one example, regions that are reduced in area are not completely eliminated from the display. Thus, even though the user is able to peruse more details regarding one of the regions, the other regions remain visible, thus allowing the user to navigate to those regions without zooming out from the current region of interest.

FIGS. 6A through 6G provide a particular example of a set of regions being navigated by a user via semantic zooming, such as by way of a mouse or similar input device. The set of regions describe what may be termed a “collaboration cloud”, in which a number of users contribute to the content shown in the various regions described below. As seen below, users may employ the collaboration cloud to send messages or requests to each other, to identify tasks that are to be undertaken by specific individuals or the group in general, and the like.

FIG. 6A depicts an initial display 600A including several regions 602, 604A, 606A, 608A, 610A, and 612A. Region 602 is a region that indicates the overall scope of the display 600A: a virtual “inbox” associated with a particular user (in this case, “Jim”). As will be seen in the remaining display examples, the “inbox” region 602 remains constant in size and informational content throughout, as the region 602 primarily provides a title for the remaining regions displayed.

Personal region 604A provides a listing of items 605A associated with the user, Jim. As discussed below, each of these items 605A belongs to one of the four information regions 606A, 608A, 610A, 612A presented in the right-hand side of the display 600A. These information regions include a “Due Today” region 606A, an “Open Tasks” region 608A, a “Projects” region 610A, and a “To Do” region 612A. Each of these regions 606A through 612A may refer to items that are generated by the user (Jim) or other people with which the user collaborates. As shown, the personal region 604A provides more detailed information by providing a list of items 605A, while other regions 606A through 612A provide a region title and a number of items accessible via that region. As shown in FIG. 6A, the personal region 604A also indicates a total number of items accessible in its region (in this case, 7).

The initial display 600A, including the particular regions 604A through 612A to be displayed, the size and location of each region, and the level of information to be presented to the user in each region, may be initially determined by the database module 308, by the user interface output module 304, by preferences specified by the user, or by some other source. In one example, the initial display 604A is based on default information which the user may modify based on personal preferences.

In one example, the user may select the “To Do” region 612A for enlargement or expansion (zoom-in) by clicking a mouse button, by rotating a mouse click wheel one position, or by some other input mechanism. In response, the display 600B of FIG. 6B may be presented to the user, in which the “To Do” region 612B has been enlarged, and the four items 613B referenced in the original version of the “To Do” region 612A are listed in some detail. More specifically, each item 613B is referenced by way of a title, a due date, and a creation date. In this example, the title of the region (“TO DO”) employs a larger font. Also in this example, the entire area associated with the display 600B is enlarged to allow presentation of details with respect to at least one of the displayed regions 604B through 612B.

To allow for more room for the expanded “To Do” region, the personal region 604B is reduced in size, resulting in removal of the previously listed items 605A, as well as rotation of the title for the personal region 604B (“JIM”) to allow more room for the “To Do” region 612B. The remaining regions (the “Due Today” region 606B, the “Open Tasks” region 608B, and the “Projects” region 610B) are expanded horizontally to occupy display space vacated by the personal region 604B.

If the user selects a zoom-in operation for the “To Do” region 612B once again to request more details regarding that region 612B, the user interface output module 304 may provide the modified display 600C of FIG. 6C. In this case, the user has selected the topmost item of the list of items 613B of FIG. 6B, resulting in the modified “To Do” region 612C displaying the entire item, including the text of the item, the due date of the item, the creation date of the item, and the name of the creator (“Julio R.”) of the item. Also presented is an icon 613C to indicate more specifically the nature of the item. As the item may be displayed completely within the area of the “To Do” region 612B prior to the most recent selection, the area occupied by the “To Do” region 612C remains unchanged, thus allowing the remaining regions 604C through 610C to maintain their areas as well. In one example, the user may alter the content of the region 612C, such as by typing changes to the text of the item directly into the region 612C.

As the unselected regions 604C through 610C remain visible, the user is free to select a zoom-in operation for another region, such as the “Open Tasks” region 608C of FIG. 6C, resulting in the modified display 600D of FIG. 6D. In response to this most recent user selection, the “Open Tasks” region 608D is expanded to reveal a listing of items 609D belonging in that category. Each of the items 609D includes a reference to the title of the item, a due date for the item, and a creation date for the item. Further, one of the items (“Approve leave request Diana Parker”) is highlighted by way of further user input, such as allowing a cursor to “hover” over the item of interest.

To allow the expansion of the “Open Tasks” region 608D, the “To Do” region 612D is reduced in size and relocated toward the bottom of the display area 600D, along with the “Projects” region 610D. As a result, the vertical order of the regions 606D, 608D, 610D, and 612D is maintained to enhance the user's ability to locate the various regions 606D, 608D, 610D, and 612D quickly. The “Due Today” region 606D and the personal region 604D maintain their previous sizes and locations since they are not affected by the expansion of the “Open Tasks” region 608D.

Presuming the user then selects the personal region 604D for a zoom-in operation, the display 600E of FIG. 6E may be presented in one example. More specifically, the personal region 605E is expanded, and each of the seven items 605E belonging to the personal region 604E are presented, with each item being denoted by a title, due date, and creation date. Again, the user has highlighted one of the items 605E (the “Prepare activity report” item) by allowing the cursor of the input device to hover over that specific item. As shown in FIG. 6E, the personal region 604E exhibits items from the regions 606E through 612E that are intended for action by the user (Jim) associated with the personal region 604E. For example, the leave requests for Peter Miller and Diana Parker originate from the “Open Tasks” region 608D of FIG. 6D, and the “Birthday call—Dennis” item is drawn from the “To Do” region 612B presented in FIG. 6B.

To allocate room for the personal region 604E to display the associated items 605E, each of the remaining regions 606E through 612E on the right-hand side of the display 600E are reduced in size. To facilitate this reduction, the items 609D previously shown in the “Open Tasks” region 608D are removed from view, and the title for each of the regions 606E through 612E are rotated to allow more room for the personal region 604E.

As illustrated in FIG. 6F, in response to the user selecting one of the items 605E of the personal region 604E (FIG. 5), the selected item (“Prepare activity report”) may be presented within the personal region 604F to reveal the text, due date, creation date, and creator name of the item. In this case, the area of the personal region 604F is not expanded, resulting in the remaining regions 606F through 612F maintaining their current size as well.

If the user then exits the expanded item, such as by selecting the “X” in the upper-right corner of the personal region 604F, the regions may revert to the previous display 600E depicted in FIG. 6E. In another example, in recognition of the user not selecting a particular region of the display 600F, the size of the regions 604F through 612F may be modified to provide a more equitable distribution of the area available in the display 600F, resulting in the display 600G of FIG. 6G. Therein, the personal region 604G is reduced in size, while the area of each of the remaining regions 606G through 612G is increased accordingly.

In at least some embodiments discussed herein, the semantic zooming functionality facilitates enhanced user navigation of hierarchically-related data. For example, a user may quickly delve into more detailed information regarding a particular topic or area of interest without relinquishing immediate access to other topics. As a result, the user is not required to zoom completely out of a particular region before accessing another, or to scan across a graphical area which may be at least partially hidden from the view of the user due to being graphically zoomed in to a particular area. Accordingly, access to several different areas of information may be provided within a relatively small display area. Such functionality may be advantageous in environments in which display area is limited, such as in mobile communication devices, especially when compared to desktop computers, laptop computers, computer tablets, and the like. However, any type of electronic display area employed to provide differing levels of information in a variety of areas may benefit from application of the various principles disclosed herein.

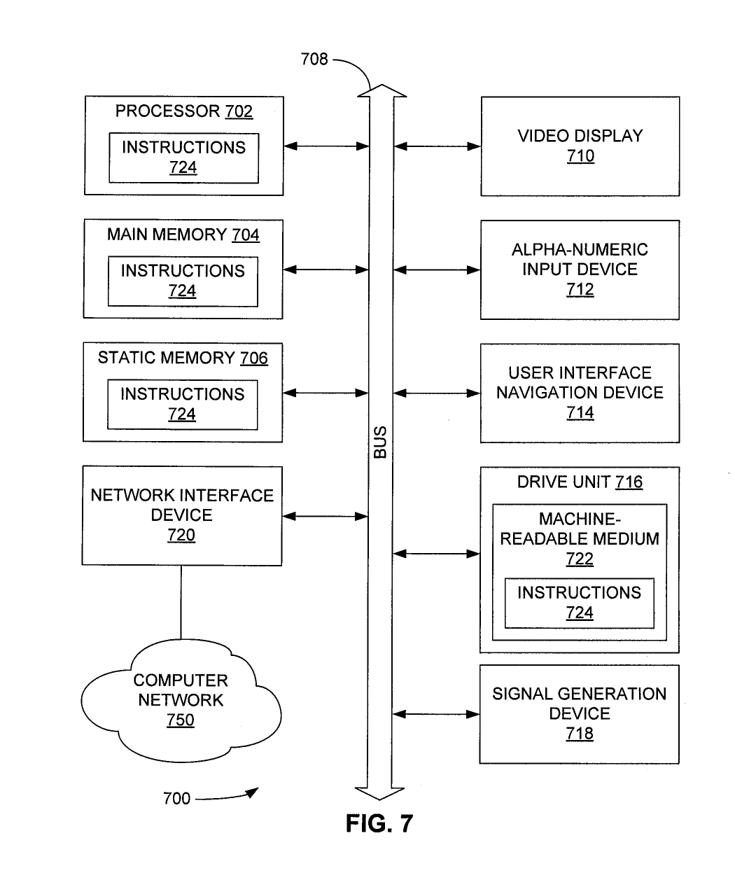

FIG. 7 depicts a block diagram of a machine in the example form of a processing system 700 within which may be executed a set of instructions for causing the machine to perform any one or more of the methodologies discussed herein. In alternative embodiments, the machine operates as a standalone device or may be connected (for example, networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 700 includes a processor 702 (for example, a central processing unit (CPU), a graphics processing unit (GPU), or both), a main memory 704 (for example, random access memory), and static memory 706 (for example, static random-access memory), which communicate with each other via bus 708. The processing system 700 may further include video display unit 710 (for example, a plasma display, a liquid crystal display (LCD), or a cathode ray tube (CRT)). The processing system 700 also includes an alphanumeric input device 712 (for example, a keyboard), a user interface (UI) navigation device 714 (for example, a mouse), a disk drive unit 716, a signal generation device 718 (for example, a speaker), and a network interface device 720.

The disk drive unit 716 (a type of non-volatile memory storage) includes a machine-readable medium 722 on which is stored one or more sets of data structures and instructions 724 (for example, software) embodying or utilized by any one or more of the methodologies or functions described herein. The data structures and instructions 724 may also reside, completely or at least partially, within the main memory 704, the static memory 706, and/or within the processor 702 during execution thereof by processing system 700, with the main memory 704 and processor 702 also constituting machine-readable, tangible media.

The data structures and instructions 724 may further be transmitted or received over a computer network 750 via network interface device 720 utilizing any one of a number of well-known transfer protocols (for example, HyperText Transfer Protocol (HTTP)).

Certain embodiments are described herein as including logic or a number of components, modules, or mechanisms. Modules may constitute either software modules (for example, code embodied on a machine-readable medium or in a transmission signal) or hardware modules. A hardware module is a tangible unit capable of performing certain operations and may be configured or arranged in a certain manner. In example embodiments, one or more computer systems (for example, the processing system 700) or one or more hardware modules of a computer system (for example, a processor 702 or a group of processors) may be configured by software (for example, an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 702 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (for example, hardwired) or temporarily configured (for example, programmed) to operate in a certain manner and/or to perform certain operations described herein. Considering embodiments in which hardware modules are temporarily configured (for example, programmed), each of the hardware modules need not be configured or instantiated at any one instance in time. For example, where the hardware modules include a general-purpose processor 702 that is configured using software, the general-purpose processor 702 may be configured as respective different hardware modules at different times. Software may accordingly configure a processor 702, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 702 that are temporarily configured (for example, by software) or permanently configured to perform the relevant operations. Whether temporarily or permanently configured, such processors 702 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 702 or processor-implemented modules. The performance of certain of the operations may be distributed among the one or more processors 702, not only residing within a single machine but deployed across a number of machines. In some example embodiments, the processors 702 may be located in a single location (for example, within a home environment, within an office environment, or as a server farm), while in other embodiments, the processors 702 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method, comprising:
presenting a display comprising a plurality of regions, each of the plurality of regions not overlapping another of the plurality of regions;
receiving a first user selection of a first region of the plurality of regions, the first region presenting a first amount of information; and
in response to the first user selection, using at least one processor of a machine,
enlarging the first region;
presenting a second amount of information in the first region greater than the first amount of information; and
shrinking at least one remaining region so that each of the plurality of regions do not overlap another of the plurality of regions.

2. The method of claim 1, the first amount of information presented in the first region comprising an information topic, the second amount of information comprising a listing of items relating to the information topic.

3. The method of claim 1, further comprising:
receiving a second user selection of the first region subsequent to the first user selection; and
in response to the second user selection, presenting a third amount of information presented in the first region greater than the second amount of information.

4. The method of claim 3, the second amount of information comprising a listing of items, and the third amount of information comprising details regarding one of the items.

5. The method of claim 4, the details comprising at least one of a creation date of the one of the items, a due data associated with the one of the items, and a name of a user associated with the one of the items.

6. The method of claim 1, further comprising:
receiving, subsequent to the first user selection, a second user selection of a second region of the plurality of regions, the second region presenting a third amount of information; and
in response to the second user selection:
enlarging the second region;
presenting a fourth amount of information in the second region greater than the third amount of information;
presenting the first amount of information in the first region; and
shrinking at least the first region so that each of the plurality of regions are not overlapping another of the plurality of regions.

7. The method of claim 1, the user selection being initiated via an activation of a button of a user input device.

8. The method of claim 1, the user selection being initiated via an activation in a first direction of a scroll wheel of a user input device.

9. The method of claim 8, further comprising:
receiving a second user selection of the first region, the second user selection being initiated via an activation in a second direction of the scroll wheel; and
in response to the second user selection:
presenting the first amount of information in the first region;
shrinking the first region; and
enlarging at least one remaining region while ensuring that each of the plurality of regions does not overlap another of the plurality of regions.

10. The method of claim 1, further comprising:
generating a query corresponding to the first user selection of the first region;
forwarding the query to a database; and
receiving the second amount of information from the database in response to the query.

11. The method of claim 10, the query being generated prior to the receiving of the first user selection.

12. The method of claim 10, the query being generated in response to the receiving of the first user selection.

13. The method of claim 1, further comprising receiving user input specifying at least one of an initial size and an initial location of each of the plurality of regions of the display, the presenting of the display being based on the user input.

14. The method of claim 1, further comprising:
receiving user input subsequent to the first user selection, the user input corresponding to the first region; and
updating the second amount of information based on the user input.

15. A non-transitory computer-readable storage medium comprising instructions that, when executed by at least one processor of a machine, cause the machine to perform operations comprising:
presenting a user interface displaying a plurality of regions simultaneously, each of the plurality of regions not overlapping another of the plurality of regions;
receiving a user selection of a first region of the plurality of regions, the first region presenting a first amount of information; and
in response to the user selection,
enlarging the first region;
presenting a second amount of information in the first region greater than the first amount of information; and
shrinking at least one remaining region so that none of the plurality of regions overlap another of the plurality of regions.

16. The non-transitory computer-readable storage medium of claim 15, the operations further comprising reducing an amount of information presented in the at least one remaining region in response to the user selection.

17. The non-transitory computer-readable storage medium of claim 15, each of the plurality of regions being a convex region.

18. A system comprising:
at least one processor of a machine; and
modules comprising instructions that are executable by the at least one processor, the modules comprising:
a user interface output module to display a plurality of regions simultaneously, each of the plurality of regions not overlapping another of the plurality of regions; and
a user interface input module to receive a selection of a first region of the plurality of regions, the first region presenting a first amount of information;
the user interface output module, responsive to the selection, to enlarge the first region, to present a second amount of information in the first region greater than the first amount of information, and to shrink at least one remaining region so that none of the plurality of regions overlap another of the plurality of regions.

19. The system of claim 18, further comprising:
a query generation module to generate a plurality of queries, each of the queries corresponding to one of the plurality of regions prior to the selection; and
a database module to generate a response for each of the queries, each of the responses comprising an amount of information to be presented in the corresponding one of the plurality of regions prior to the selection.

20. The system of claim 19, the query generation module to generate a second query corresponding to the selection of the first region, the database module to generate a second response for the second query, the second response comprising the second amount of information.
